(19) United States
(12) Patent Application Publication
(10) Pub. No.: US 2009/0012851 A1
(43) Pub. Date: Jan. 8, 2009

(54) WIRELESS TOLL COLLECTION SYSTEM

(76) Inventor: Miroslav Marc, Kranj (SI)

Correspondence Address: CONNOLLY BOVE LODGE & HUTZ LLP, 1875 EYE STREET, N.W., SUITE 1100, WASHINGTON, DC, 20006, US

(21) Appl. No.: 11/573,852

(22) PCT Filed: Aug. 19, 2004
(86) PCT No.: PCT/SI2004/000027

§ 371 Date: Sep. 19, 2008

(51) Int. Cl. G07B 15/02

(52) U.S. Cl. 705/13; 235/384

(57) ABSTRACT

An assembly of devices for charging and cashless automatic payment of costs, e.g. toll, bridge toll, entrance and the like, charged on the basis of geographical locations and/or geographical areas and for the information on the events on the basis of the above-mentioned charging consists of a control centre (1), an assembly of devices (2), of which one is located in each means (3), e.g. in a vehicle, boat, etc., of control devices (4) and (40) for physical control of operation or existence of devices (2) in means (3), situated in the area of a payable service, and of transmitters (5) of geographical co-ordinates, whereas the transmitters (5) are preferably a public or for this purpose intended satellite or terrestrial means and the entire procedure and control of payment is anonymous, until it is established via control procedures that payment is not effected properly due to a failure of the device (2) or due to unauthorized intervention into the device (2).

### SUBJECT OF INVENTION

The subject of the invention is an assembly of devices for calculation and cashless automatic payment of costs, charged on the basis of geographical locations and/or geographical areas, as well as for informing on the events on the basis of the mentioned calculation. The assembly of the invention is preferably intended as a means for the payment of tolls, bridge tolls, tunnel tolls, parking charge and also in maritime traffic. It is also applicable elsewhere where optional services are to be paid, whereas the price of the services is linked to an individual geographical location or area.

### TECHNICAL PROBLEM

A technical problem solved by the present invention is how to conceive such assembly of devices that will allow calculation and cashless automatic payment of costs for the use of e.g. roads, bridges, tunnels, entrances, parking and the like, whereas for instance the use of sections of roads, bridges, tunnels, parkings, other locally defined services and the like used by an individual means e.g. vehicle, boat etc. is defined by a foreseen geographical location and/or geographical area, where the means are situated and the use of which has to be paid for; the calculation of costs will also include optional characteristics of an individual means, properties of an individual section of roads, bridges, tunnels and similar and also various payment terms as to the mode payment (advance payment, payback, payment on permanent order, discounts, etc.). All the data needed for the calculation of a toll and linked to a user of a vehicle or a payer, e.g. on locations, line, date and time of routes with a treated vehicle, will be inaccessible to any central unit for the control of calculation and payment of costs, preferably the main computer centre, in the sense of confidentiality of personal data until payments are properly carried out or until the device in a vehicle operates properly and at the same time the revenues from the paid use will be justly divided among several owners of highways, other roads, tunnels, bridges, etc. based on the actual use.

The data on the type of a transport means (without any connection with the ownership of same) and the time when it was on the area, the use of which is payable, can be used for statistical analyses of load or use of payable areas.

Moreover the assembly of the invention should meet various application requirements, among others also the European Directive 2004/0081 on mutual compatibility of electronic systems for the payment of tolls in EU.

### PRIOR ART

Known cashless automatic modes of payment are based on a prepaid electronic card, from which the costs for the used section are deducted when a vehicle passes a control toll gate. A disadvantage of this solution lies in that in reasonable price limits it is not possible to have such a toll gate for automatic payment with a prepaid electronic card that would take a payment category of a vehicle into consideration, the price is the same for all types of vehicles, which is not in compliance with the above-mentioned European Directive.

A further problem of any payment at toll gates is a high cost of the entire infrastructure of toll gates. Erection of such toll gate often represents a spatial problem. As a consequence we face compromises. Lower speed when going through such a station diminishes the flow of a road. That area faces an increase of exhaust gases and dust particles of brake facings.

A device of this type is also known from the Slovene patent SI 20996 (Marc). With respect to the above described technical problem it has a disadvantage that the data on the owner of a vehicle and the movement of the vehicle on payable road sections are processed in a central computer due to the calculation of the price of a toll and are thus accessible to unauthorized persons.

Moreover, there is a known method of such type of charging and tracking of vehicles from the patent US 2002072963 (Jonge Wiebren de). The essential characteristic of this solution is in that it is based on the data on the mileage submitted by a distance meter, preferably a kilometre meter, to the charging centre. This solution thus deviates from one of the basic principles on the protection of personal data, namely that the data for charging should be inaccessible to anyone including the charging centre.

In compliance with the European Directives on the Protection of Personal Data there is a need for such a device that would assure a higher level of protection of personal data by simultaneously respecting the principle of payment of actual costs, of preventing falsification and misuse, of charging of toll that does not disturb traffic, of low costs of toll charging.

### SOLUTION TO THE TECHNICAL PROBLEM

The described technical problem is solved by an assembly of devices of the invention, which is characterized in that it consists of a computer central control centre linked via a two-way wireless connection, preferably a mobile phone connection, with devices in individual means, e.g. vehicles, whereas each device for instance in a vehicle is at the same time connected via a one-way wireless connection with public or special transmitters, satellite or terrestrial transmitters, to determine a geographical coordinate, on which the device is located in the moment when the process of charging for costs or control of operation of the device in the means is performed, and from control devices on certain points in the areas where the payment of consumption is foreseen. The device in each means calculates the payment of services, e.g. toll, on the basis of prices for individual charging sections within the account filled in an optional and pre-arranged way, without transmitting the balance of the account, location of use and other data that could identify the owner of a vehicle, to the control centre supervising the correct operation of each device on the basis of a command to a device to calculate a predetermined formula that among others also contains its current geographical co-ordinate, payment category, price for the service in that area and similar data on at least one previous charging checkpoint that the control centre unambiguously determines on the basis of the entire map of calculation points and at the same time there are physical points for the control of means foreseen, e.g. vehicles that would make use of services without having the adequate device turned on or even built-in, because entry into the payable area with the device of the invention is physically free or physically secured e.g. by a gate.

In order for the assembly of the invention to operate, it is presumed that each geographical area (sector)—in which payments with the assembly of the invention are to be effected—is attributed to one charging unit, e.g. one provider of services. Individual areas are divided in geographical sections (segments) defined by two geographical co-ordinates. The essential characteristic of sections is that within their scope there is only one payable service with its price, whereby this service does not come in contact with another optional payable service of any other section (segment). If several sections (segments) e.g. cross-roads, viaducts, circular cross-roads are linked to one geographical co-ordinate, then each individual section (segment) is identified in the device in the means, the vehicle on the basis of a comparison of previously driven co-ordinates with possible next co-ordinates reachable from the current co-ordinate. This legality also contributes to a precise analysis of anonymous data received into the control centre from individual devices in means using these services.

An assembly of the invention may also include several charging areas linked to a wide variety of payable services, charging and statistical limitations. The assembly of the invention can thus charge and control the areas of several owners, the areas that cover several administrative units, also countries, then charging of short-term services, e.g. entrances for a single-day event, charging of purchases on geographically separated points, e.g. at gas stations and the like.

In order that the present invention be more readily understood, an embodiment thereof will now be described by way of example with reference to the accompanying drawing in which:

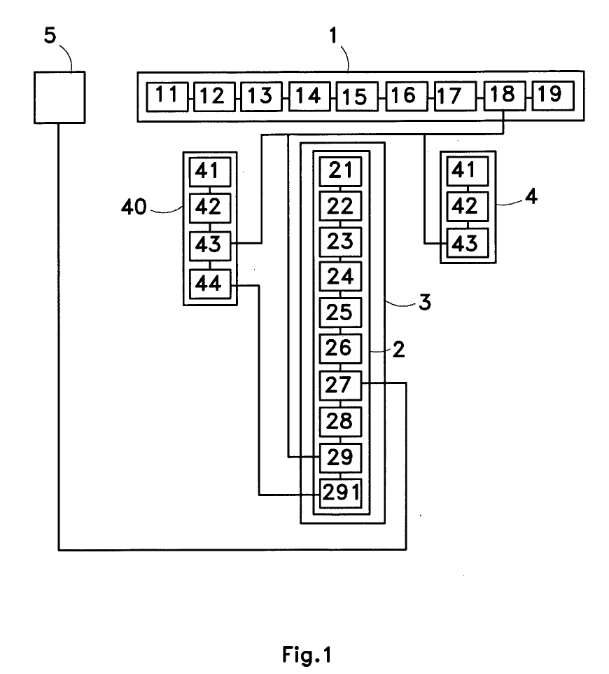

FIG. 1 schematic view of the assembly of the invention,

An assembly of devices for charging and cashless automatic payment of costs, e.g. toll, bridge toll and the like, charged on the basis of geographical locations and/or geographical areas and for the information on the events on the basis of the above-mentioned charging consists of a control centre 1, an assembly of devices 2, of which one is located in each means 3, e.g. in a vehicle, boat, etc., of control devices 4 and 40 for physical control of operation or existence of devices 2 in means 3, situated in the area of a payable service, and of transmitters 5 of geographical co-ordinates.

The control centre 1 is basically a computer of an optional type and configuration and is managed by a service provider, whereas the services are payable on the basis of locations or areas, on which a user of a road—the toll fee payer—is present.

The control centre 1 has a central processing unit 11, a list 12 of users, who applied for the payment of the services by means of an assembly of the invention, a list 13 of charging points determined by geographical co-ordinates, a list 14 of control points that are also defined by geographical co-ordinates, then a pricelist 15 of services linked to the charging points of the list 13, a unit 16 for the control of the payment of a service that each user of a location or area is obligated to pay, a unit 17 for the analyses of services, e.g. traffic, a unit 18 for wireless communication with the devices 2, 4 and 40, and known auxiliary devices 19, needed for technical and communications correct operation of the centre 1 or of each assembly of the invention. The processing unit 11 links all the mentioned units among themselves both physically and in programmes. The unit 11 also communicates with devices 2 in means, e.g. vehicles, with the devices 4 and 40 via the unit 18 for communication.

The device 2 in the means e.g. a vehicle contains a processing unit 21 with auxiliary units for the proper operation of the device, a list 22 of charging checkpoints determined by geographical co-ordinates, whereby the list 22 is updated in a certain time interval by the control centre 1 via the unit 18 for wireless communication, then a list 23 of checkpoints which are also defined by geographical coordinates, whereby this list is updated by the control centre 1 via the unit 18 for wireless communication, then a pricelist 24 of services linked to the charging checkpoints in compliance with the list 13 that equals the list 22 in the device 2, whereby this list in a certain time interval sends information to the control centre 1 via the unit 18 for wireless communication, then a unit 25 for charging for the services, e.g. toll, a unit 26 for the storage of all data related to the charging of a service, a unit 27 for the reception of the geographical co-ordinate of the location, on which the device 2 is located in each moment, a unit 28 for the measurement of the duration of a means e.g. vehicle on a certain charging checkpoint or a certain area determined by several charging checkpoints, a unit 29 for wireless communication with the control centre 1 and optionally also a unit 291 for wireless communication with a special control device owned by an official body, preferably in an official car. Such communication can make use of devices with special optical or short-wave signal means (photo cells, infrared diodes, DSRC, WLAN, CALM, Bluetooth, . . . ).

The control devices 4 are situated on the area where the payment of services with the device of the invention is foreseen. The devices contain a processing unit 41 with auxiliary units for correct operation of the device 4 as a whole, then a unit 42 for detecting and identifying the means with the device 2, and a unit 43 for wireless communication with the control centre 1. Special control devices 40 are intended to be used by official persons, preferably in official cars. These devices contain apart from the units 41, 42, and 43 also a unit 44 for direct communication with the unit 291 in the device 2.

The assembly of the invention also includes transmitters 5 of geographical coordinates needed by the device 2. The transmitter 5 is preferably a public or for this purpose intended satellite or terrestrial means. This invention does not treat the transmitter 5 as such, it is included in the invention only as a source of geographical coordinates of the current position of the means, e.g. a vehicle.

The assembly of the invention operates in the following way: after a contract is concluded between the provider and each user, in which different mutual terms and obligations are defined, a user is attributed a device 2 to be integrated into the means, e.g. vehicle by an authorized institution or person. Prior to the arrangement and operation of the assembly of the invention, the provider and the user are to determine the mode of payment of services: either a prepayment mode or a credit mode in compliance with the set term and financial programme.

The device 2, after having been properly installed into the means, e.g. a vehicle, contains also identification data on the owner of the means, e.g. the vehicle, and the terms and mode of payment or charging for the services, e.g. toll, as well as a sort or type of a means, e.g. personal vehicle, motor cycle, bus, truck, because the prices may also depend on the sort or type of a means. This datum is also important for a statistical (anonymous) analysis of the events for which the costs for the use are paid, e.g. for roads. All these data are preferably stored in its unit 25 for the charging of services or its unit 26 with “unvolatile memory”, and also in the list 12 of users in the control centre 1. All the data are automatically stored in the unit 26, whereby it is taken as a default that all the data in the unit 26 are of personal nature, i.e. confidential. Only an authorized person can access them via a special hardware or via the control centre 1 and that only in cases when it is established that the device 2 does not operate properly and that the cause of improper operation is to be detected or in case of a court warrant in order to obtain data in court proceedings. As far as the invention is concerned, we are only interested in the confidentiality of data in so far the entry into the unit 26 has to be protected in a cryptographic form that said legal status is ascertained.

The device 2 in the means, e.g. a vehicle, is turned on independently of the will of the user when the means is in use, e.g. when the motor of a vehicle is turned on or always via its internal power source, e.g. battery, to which only an authorized person has access. The mode of connection of the device 2 depends on contractual terms and provisions of billing for the services and does not enter the essence of the invention in the technical sense.

As soon as the device 2 is turned on, it is prepared to receive data from the control centre 1 via its unit 29. The data are sent in selected time intervals via its unit 18 for the communication preferably to all devices 2 simultaneously. These data encompass a set of geographical coordinates and other data of charging checkpoints that the device 2 stores in its list 22 of charging checkpoints, then a set of data on control checkpoints that are stored in the list 23 and an adequate set of data on prices that are stored by the device 2 in its pricelist 24 of services. Preferably a public wireless phone network is used to serve this purpose. Each device 2 is thus prepared for automatic charging of services, e.g. toll, parking toll, etc.

After the device 2 has received and stored the mentioned data, it uses its processing unit 21 and the unit 27 for the reception of a geographical coordinate in the foreseen time interval to receive its current geographical coordinate from the transmitter 5 of geographical coordinates. Preferably one of the existing satellite systems, e.g. GPS or GALILEO is used to serve this purpose. However, another mode can be used, e.g. terrestrial aerials of wireless telephony or terrestrial or satellite means erected to this purpose. It is a default for the present invention that the device 2 is adapted to receive data on its geographical coordinate from at least one type of transmitters of these data.

The processing unit 21 compares each current geographical coordinate corresponding to the current location of the means containing the device 2 in the area with the list 22 of charging points, i.e. a set of geographical coordinates corresponding to the locations in the area, on which the service or consumption is charged. This procedure takes the prescribed tolerance into account that the control centre 1 reports to the device 2 together with the data on charging and control checkpoints, prices and other that has been described above. The tolerance of a geographical coordinate of each charging checkpoint determines a certain geographical area in which the means, e.g. a vehicle, is present, in order that the automatic process of charging is initiated. The processing unit 21 uses the entered formula to calculate the costs on the basis of the adaptation of the basic price from its pricelist 24 with respect to any charging checkpoint from its list 22 of charging checkpoints, by considering other prescribed parameters, e.g. charging category of the means, e.g. vehicle, in this case a personal vehicle, bus, etc., whereby the data are stored in the device 2. Each charging parameter and charging amount is stored in an unvolatile manner in the unit 26 for the storing of all data in the device 2 itself.

The device 2 at the same time keeps record on the balance on its account, on both the prepayment or credit account. When the payment terms are over the limits (prepayment amount or the amount and the payment term for the settling of the credit account) as foreseen in the contract between the provider and the user, a warning signal is triggered to the user on the basis of such parameters and data, stored in various units in the device 2. The warning sign may be a written and/or audible information on the device 2 that a user within a prescribed time interval returns the balance on his account to the form as contractually arranged. Should a user not act in compliance with the warning and the contractual provisions, the device 2 notifies the control centre 1 of its not harmonized balance and also of the identification data of the user.

The control centre 1 also performs checking of operation of all devices 2 by means of control checkpoints on the selected geographical coordinates that the operator of the control centre can also change in compliance with an optional principle. As described above, the control centre 1 sends via wireless communication to all devices 2 also the set of currently valid control checkpoints defined at least with their geographical coordinates, the tolerance field for the charging and if need may be with other data needed for the automatic implementation of the process of controlling of operation of the devices 2. This process operates in the following way: when an individual device 2 in the means, e.g. a vehicle—upon its regular checking the current location defined by the geographical coordinate received from the transmitter 5 of geographical coordinates—determines upon regular checking its current geographical coordinates against the list 23 of control checkpoints that it is within the area of a geographical coordinate of a control checkpoint, and performs a control calculation of at least the latest charging and based on the entered command of the calculation of one more or several previous calculations. The processing unit 21 takes the data for its control calculation from the unit 26 for the storage of data, i.e. the actual data on previous calculations. Apart from these data, other data may be entered into the control calculation, like technical data, which are not included in the money calculation it can perform services or with the control calculation. Such data are e.g. digitalized values that are detected in the device 2 by various sensors or are generated in the processing unit 21 and point at a change of power supply, the latest turn-on of the device 2, possible unauthorized opening of the device 2, illogical sequence of charging checkpoints, on which the charging for services in the previously determined number of calculations was performed. Via an anonymous wireless connection the device 2 sends this result and also the datum on the charging category of the means, e.g. a vehicle, in which it is installed, the address of the control checkpoint and the above mentioned technical data to the control centre 1. The device does not send the identification of the owner of the means, e.g. a vehicle. By having such message from the device 2 and its own data in the list 14 of control checkpoints, in the pricelist 15 the control centre 1 has enough data for its processing unit 11 to perform the same control charging or charging according to the same principle, yet with its own data from the list 14, the pricelist 15 and other data equal to the adequate data in the device 2 if it is equipped with proper data and if it operates by the proper rules. If the unit 11 detects harmonized results, the process is therewith completed and into the unit 26 for the storing of all data is recorded the result of the control calculation. In case of different calculations in the unit 11 and the result sent by the device 2, there is only one possible conclusion, namely that the device 2 does not operate properly. The results calculated in the centre 1 and the device 2 are recorded in both the centre 1 and the device 2 owing to the later processing of the cause of irregularity. Apart from that the identification data of the means or its owner are transmitted via wireless connection from the device 2 into the control centre 1. The owner is notified optically and/or acoustically or even in writing, what the next measure should be, e.g. check of the device with an authorized person within a certain time period. Since there is a large number of data taken into account in the control calculation that were mentioned above, logical operators in the processing unit 11 can immediately detect some errors in the device 2 and perform an adequate pre-programmed measure, e.g. failure of the unit 27 for the reception of geographical coordinates. Further measures that follow a detected error in the device 2 are no longer subject of the present invention.

The invention also foresees several types of physical control of operation of the devices 2 in the means, e.g. vehicles. Physical control is necessary because the access to the area of payable services is uncontrolled and free. For instance access to a road with payable toll is no longer equipped with toll stations and/or gates.

The first type of physical control is anonymous and is performed as follows: control devices 4 for the implementation of physical control of operation of the devices 2 are located geographically in the vicinity and follow the operation of charging and/or control checkpoints. The vicinity of the charging checkpoint and the physical checkpoint is such that in this area only that device 2 in the means, e.g. a vehicle may be present that was the last to transmit the data to the control centre 1 when crossing the charging or control checkpoint.

A device 4 of physical control operates as follows: the device 2 having completed the checking control on a checkpoint by sending to the control centre 1 only the data on its calculation category and the address of the checkpoint that the centre 1 needs to perform statistical analysis of services and to obtain a result of the control calculation checks via its unit for wireless communication 43 in the control centre 1 whether within the latest time period optional means sent to the centre 1 its necessary data, e.g. calculation category and the address of the checkpoint, said device 4 detects e.g. by a photo cell or another similar sensor whether means e.g. a vehicle is present within the territory between the closest checkpoint and the device 4, whereas the vehicle must contain also the device 2. If the answer is affirmative, the only conclusion is that the device 2 in the means is operative. The entire procedure is in course without the identification of the means or the owner being determined. If irregular operation or absence of the device is established, identification of the means, e.g. a vehicle, is triggered mechanically, e.g. by taking a photo, by scanning and/or physical stopping of a vehicle by an authorized person.

It is clear from the above that the assembly of the invention respects the principles on anonymity of the owner of the means in which the device 2 for the calculation of services is present, until control procedures show any irregularity of the operation of the device 2 or even its absence, regardless of whether a technical failure of the device 2 is concerned or unauthorized handling with it or its turning off or removal.

Moreover, the invention foresees non-anonymous forms of physical control of operation of the devices 2, in which various data linked to the owner of the means, e.g. a vehicle, are taken into consideration. Since such control is no longer anonymous, it must be harmonized with adequate legislation. The control procedure must only be performed by official or authorized persons. Therefore all parts of the assembly of the invention must be so technically assured that fraudulent use cannot take place.

The continuation presents an embodiment of such non-anonymous physical control when the invention is used for the payment of a toll. For such control an official vehicle is foreseen with an official person, whereby the control vehicle is equipped with a device 40. The device 40 operates in a way that the official vehicle with an official person drives in the vicinity, preferably behind the controlled vehicle: first the physical control device 4 with its unit 42 for detecting and identifying the means, e.g. a vehicle, reads/scans the registration plate of the vehicle and then it connects via its unit 43 for wireless connection with the control centre 1, which uses the list 12 of users to establish wireless communication via the unit 18 with the device 2 in the controlled means via its unit 29. A further procedure can be the same as with the above mentioned anonymous control. It may also be that the physical control device 4 from a control vehicle establishes wireless communication directly via its unit 44 with the device 2 in the vehicle via its unit 291. When the connection between the device 2 in a vehicle and the physical control device 40 is established, a normal control process is carried out. The same control procedure is in course as if the device 2 came across a control checkpoint. The only difference is that in this case it is already identified via physical identification of the vehicle (e.g. registration plate).

The described embodiment and the described use for the payment of a toll do not limit the scope of the invention. It is obvious that the assembly of the invention can also be used for the charging of parking toll for vehicles and other similar services when the charging takes into account not only the charging checkpoint but also the location of the means, its calculation category and the time of use. The time on a certain location where the means are present is measured by a unit 28 in the device 2 for the measurement of the duration of the presence of the means, e.g. vehicle, on a certain billing checkpoint or area determined by several calculation checkpoints. This way can for instance be used to additionally calculate the fee for the presence of a vehicle and thus its user and other people in a certain area, e.g. national park. The assembly of the invention can moreover be used for the charging of entrance fees to an event linked to a geographical point or territory. The assembly of the invention preferably intended for the payment of a toll can be upgraded for the payment of fuel purchase on road self-service gas stations, especially on gas stations without personnel. It could be performed by simple communication data via which the data for charging (type of fuel, quantity and price, place and date of services) from the fuel apparatus are sent to the device 2. The rest of the procedure is the same as already described.

The assembly of the invention can also be adapted for use e.g. in maritime traffic for the calculation of use of payable areas, like canals, national parks, roads, etc.

If an additional manual entry is foreseen on the device 2, e.g. via a keyboard, let say an entry of a password, an optional money transaction can be effected via the device. However, prior to that a procedure must be carried out in the control centre 1 in that it has charging and control data stored that the centre 1 sends to the user of the optional device 2 in an anonymous way, until the control procedures of operation operate properly.

This is the advantage over other cash free payments of anything, in which anonymity is excluded or can simply be determined, e.g. when paying with paying cards, mobile phones, etc.

It is understandable that a man skilled in the art can conceive other embodiments based on the description of the invention and its embodiment with respect to e.g. additional calculation requirements in payment, without circumventing the characteristics of the invention described in the appended patent claims.

1. Assembly of devices for charging and cashless automatic payment of costs, e.g. toll, bridge toll, entrance and the like, charged on the basis of geographical locations and/or geographical areas and for the information on the events on the basis of the above-mentioned charging consists of a control centre (1), an assembly of devices (2), of which one is located in each means (3), e.g. in a vehicle, boat, etc., of control devices (4) and (40) for physical control of operation or existence of devices (2) in means (3), situated in the area of a payable service, and of transmitters (5) of geographical co-ordinates, whereas the transmitters (5) are preferably a public or for this purpose intended satellite or terrestrial means and the control centre (1) is basically a computer of an optional type and configuration and is managed by a service provider, whereas the services are payable on the basis of locations or areas, on which a user of a road—the toll fee payer—is present,
characterized in that
the control centre (1) has a central processing unit (11), a list (12) of users, who applied for the payment of the services by means of an assembly of the invention, a list (13) of charging points determined by geographical co-ordinates, a list (14) of control points that are also defined by geographical co-ordinates, then a pricelist (15) of services linked to the charging points of the list (13), a unit (16) for the control of the payment of a service that each user of a location or area is obligated to pay, a unit (17) for the analyses of services, e.g. traffic, a unit (18) for wireless communication with the devices (2), (4) and (40), and known auxiliary devices (19), needed for technical and communications correct operation of the centre (1) or of each assembly of the invention whereby the processing unit (11) links all the mentioned units among themselves both physically and in programmes and simultaneously communicates with devices (2) in means, e.g. vehicles, with the devices (4) and (40) via the unit (18) for communication;
the device (2) in the means e.g. a vehicle contains a processing unit (21) with auxiliary units for the proper operation of the device, a list (22) of charging checkpoints determined by geographical co-ordinates, whereby the list (22) is updated in a certain time interval by the control centre (1) via the unit (18) for wireless communication, then a list (23) of checkpoints which are also defined by geographical coordinates, whereby this list is updated by the control centre (1) via the unit (18) for wireless communication, then a pricelist (24) of services linked to the charging checkpoints in compliance with the list (13) that equals the list (22) in the device (2), whereby this list in a certain time interval sends information to the control centre (1) via the unit (18) for wireless communication, then a unit (25) for charging for the services, e.g. toll, a unit (26) for the storage of all data related to the charging of a service, a unit (27) for the reception of the geographical co-ordinate of the location, on which the device (2) is located in each moment, a unit (28) for the measurement of the duration of a means e.g. vehicle on a certain charging checkpoint or a certain area determined by several charging checkpoints, a unit (29) for wireless communication with the control centre (1) and optionally also a unit (291) for wireless communication with a special control device owned by an official body, preferably in an official car;
the control devices (4) situated on the area where the payment of services with the device of the invention is foreseen contain a processing unit (41) with auxiliary units for correct operation of the device (4) as a whole, then a unit (42) for detecting and identifying the means with the device (2), and a unit (43) for wireless communication with the control centre (1);
special control devices (40) that are intended to be used by official persons, preferably in official cars contain apart from the units (41), (42), and (43) also a unit (44) for direct communication with the unit (291) in the device (2).

2. Assembly according to claim 1, characterized in that the device (2), after having been properly installed into the means, e.g. a vehicle, contains also identification data on the owner of the means, e.g. the vehicle, and the terms and mode of payment or charging for the services, e.g. toll, as well as a sort or type of a means, e.g. personal vehicle, motor cycle, bus, truck, in compliance with a concluded contract between the provider and each user.

3. Assembly according to claim 1, characterized in that the data on prices of use are preferably stored in a unit (25) for the charging of services or a unit (26) with “unvolatile memory”, and also in the list (12) of users in the control centre (1), whereby it is taken as a default that all the data in the unit (26) are of personal nature, i.e. confidential and only an authorized person can access them via a special hardware or via the control centre (1) and that only in cases when it is established that the device (2) does not operate properly and that the cause of improper operation is to be detected or in case of a court warrant in order to obtain data in court proceedings.

4. Assembly according to claim 1, characterized in that the device (2) in the means, e.g. a vehicle, is turned on independently of the will of the user when the means is in use, e.g. when the motor of a vehicle is turned on or always via its internal power source, e.g. battery, to which only an authorized person has access.

5. Assembly according to claim 1, characterized in that the device (2) after having been turned on is prepare to receive data from the control centre (1) via its unit (29), whereby the data are sent in selected time intervals via its unit (18) for communication preferably to all the devices (2) simultaneously, whereby these data include a set of geographical co-ordinates and other data of charging checkpoints that the device (2) stores in its list (22) of calculation point, then a set of data on control checkpoints stored in a list (23), then an adequate set of data on prices stored by the device (2) in its pricelist (24) of services.

6. Assembly according to claim 1, characterized in that public wireless phone network is used for the communication between the device (1) and the devices (2), whereby each device (2) is prepared for automatic calculation of services, e.g. toll, parking, etc.

7. Assembly according to claim 1 characterized in that the device (2) after having received the data from the device (1) and having stored them, uses its processing unit (21) and a unit (27) for the reception of a geographical co-ordinate in a foreseen time interval and received its current geographical co-ordinate from the transmitter (5) of geographical co-ordinates.

8. Assembly according to claim 1, characterized in that the processing unit (21) compares each current geographical coordinate corresponding to the current location of the means containing the device (2) in the area against the list (22) of charging points, i.e. a set of geographical coordinates corresponding to the locations in the area, on which the service or consumption is charged, whereby this procedure takes the prescribed tolerance into account that the control centre (1) reports to the device (2) together with the data on charging and control checkpoints, prices and the like.

9. Assembly according to claim 1, characterized in that the processing unit (21) uses the entered formula to calculate the costs on the basis of the adaptation of the basic price from its pricelist (24) with respect to any charging checkpoint from its list (22) of charging checkpoints, by considering other prescribed parameters, e.g. charging category of the means, e.g. vehicle, in this case a personal vehicle, bus, etc., whereby the data are stored in the device (2).

10. Assembly according to claim 1, characterized in that each charging parameters and charging amounts are stored in an unvolatile manner in the unit (26) for the storing of all data in the device (2) itself, whereby the device (2) at the same time keeps record on the balance on its account, on both the prepayment or credit account and sends the user a warning signal that he/she does not act in compliance with contractual terms.

11. Assembly according to claim 1, characterized in that the control centre (1) also performs checking of operation of all devices (2) by means of control checkpoints on the selected geographical coordinates that the operator of the control centre can also change in compliance with an optional principle.

12. Assembly according to claim 1, characterized in that the control centre (1) in order to trigger the operation of devices (2) sends via wireless communication to all devices (2) also the set of currently valid control checkpoints defined at least with their geographical coordinates, the tolerance field for the charging and if need may be with other data needed for the automatic implementation of the process of controlling of operation of the devices (2).

13. Assembly according to claim 1, characterized in that checking of operation of each device (2) is performed in a way that in the moment when the device (2) in the means, e.g. a vehicle—upon its regular checking the current location defined by the geographical coordinate received from the transmitter (5) of geographical coordinates—determines upon regular checking its current geographical coordinates against the list (23) of control checkpoints that it is within the area of a geographical coordinate of a control checkpoint, and performs a control calculation of at least the latest charging and based on the entered command of the calculation of one more or several previous calculations, whereas the processing unit (21) takes the data for its control calculation from the unit (26) for the storage of data, i.e. the actual data on previous calculations, whereas apart from these data, other data may be entered into the control calculation, like technical data, which are not included in the money calculation or with the control calculation, e.g. digitalized values that are detected in the device (2) by various sensors or are generated in the processing unit (21) and point at a change of power supply, the latest turn-on of the device (2), possible unauthorized opening of the device (2), illogical sequence of charging checkpoints, on which the charging for services in the previously determined number of calculations was performed, at the end of which the device (2) uses an anonymous wireless connection to send this result and also the datum on the charging category of the means, e.g. a vehicle, in which it is installed, the address of the control checkpoint and the above mentioned technical data to the control centre (1).

14. Assembly according to claim 1, characterized in that the device (2) does not send information on identification of the owner of the means, e.g. vehicle to the control centre (1).

15. Assembly according to claim 1, characterized in that the control centre (1) with its processing unit (11) performs the same control charging or charging according to the same principle as the device (2), yet with its own data from the list (14), the pricelist (15) and other data equal to the adequate data in the device (2) if it is equipped with proper data and if it operates by the proper rules on the basis of which—in case of harmonized results of the device (1) and the device (2)—the process is therewith completed and into the unit (26) for the storing of all data is recorded the result of the control calculation, in the opposite case the results calculated in the centre (1) and the device (2) are recorded in both the centre (1) and the device (2) and via wireless connection from the device (2) into the control centre (1) is transmitted the identification data on the means or its owner, said owner being notified via auxiliary means on the device (2) optically and/or acoustically or even in writing, what the next measure should be, e.g. check of the device with an authorized person within a certain time period.

16. Assembly according to claim 1, characterized in that the first type of physical control is anonymous and is performed in a way that the control devices (4) for the implementation of physical control of operation of the devices (2) are located geographically in the vicinity and follow the operation of charging and/or control checkpoints, whereby the vicinity of the charging checkpoint and the physical checkpoint is such that in this area only that device (2) in the means, e.g. a vehicle may be present that was the last to transmit the data to the control centre (1) when crossing the charging or control checkpoint.

17. Assembly according to claim 1, characterized in that the device (4) of physical control operates in a way that the device (2) having completed the checking control on a checkpoint by sending to the control centre (1) only the data on its calculation category and the address of the checkpoint that the centre (1) needs to perform statistical analysis of services and to obtain a result of the control calculation checks via its unit for wireless communication (43) in the control centre (1) whether within the latest time period optional means sent to the centre (1) its necessary data, e.g. calculation category and the address of the checkpoint, whereas in case of irregular operation or absence of the device (2), identification of the means, e.g. a vehicle, is triggered mechanically, e.g. by taking a photo, by scanning and/or physical stopping of a vehicle by an authorized person, the procedure being otherwise anonymous.

18. Assembly according to claim 1, characterized in that there are non anonymous types of physical control of operation of devices (2), in which various data linked to the owner of the means, e.g. vehicle, are taken into consideration.

19. Assembly according to claim 1, characterized in that for non-anonymous physical control an official vehicle is foreseen with an official person, whereby the control vehicle is equipped with a device (40) operating in a way that the official vehicle with an official person drives in the vicinity, preferably behind the controlled vehicle and uses its unit (42) to detect and identify the means, e.g. a vehicle, by reading/scanning the registration plate of the vehicle and then connects via its unit (43) for wireless connection with the control centre (1), which uses the list (12) of users to establish wireless communication via the unit (18) with the device (2) in the controlled means via its unit (29) and then continues the procedure as above with the above mentioned anonymous control.

20. Assembly according to claim 18, characterized in that the physical control device (4) from a control vehicle can establish wireless communication directly via its unit (44) with the device (2) in the vehicle via its unit (291) and then a normal control process is carried out as if the device (2) came across a control checkpoint, the only difference being that in this case it is already identified via physical identification of the vehicle (e.g. registration plate).

21. Assembly according to claim 1, characterized in that it is useful for the calculation of parking fees of vehicles or other similar services, when the calculation not only includes the charging checkpoint, location of the means, its charging category but also the time of use, the assembly of the invention can also be used to charge entrance fees to an event linked to a geographical point or territory, then for the payment of a fuel purchase on road self-service gas stations, especially on gas stations without personnel by simple communication data via which the data for charging (type of fuel, quantity and price, place and date of services) from the fuel apparatus are sent to the device (2), then in maritime traffic for the calculation of use of payable areas, like canals, national parks, roads, etc., then with a possibility of manual entry of passwords it can be used to effect an optional monetary transaction, for which first a procedure in the control centre (1) is foreseen by that it contains all stored calculation and control data that are reported the centre (1) by a manual entry of an operator of an optional device (2), still in an anonymous way, until the control procedures of operation show proper operation.
